(19) United States
(12) Patent Application Publication
(10) Pub. No.: US 2003/0059007 A1
(43) Pub. Date: Mar. 27, 2003

(54) System and method for automatic mailbox owner and caller identification integration

(76) Inventor: William J. Beyda, Cupertino, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 09/965,372

(22) Filed: Sep. 26, 2001

(51) Int. Cl. H04M 1/64

(52) U.S. Cl. 379/88.19; 379/67.1

(57) ABSTRACT

A voice mail system includes a database (210) associating a plurality of calling party telephone numbers with a voice mail box. The system further includes a calling party telephone number identification unit (204) for determining the number of a calling party. The system is accessible from external to the system by dialing an access telephone number. When a user from external to the system calls in, the calling party telephone number identification unit (204) reads the number of the calling party. The database is accessed to determine if the calling party telephone number is associated with a system mailbox. If so, the system lets the user access the mailbox by entry of a password. Otherwise, the system requires the user to enter a specific mailbox number.

### BACKGROUND OF THE INVENTION

1. Field of the Invention

The present invention relates to telecommunications devices and, in particular, to an improved system and method for voice mail access.

2. Description of the Related Art

Voice messaging or voice mail systems are well known features of telephony systems, such as private telephone systems based on private branch exchanges (PBX) or local area networks (LANs). Typically, in such systems, users who want access the voice mail system from their desk telephones dial an access code and push the # key. The voice mail system then uses the dialed-from phone number as the mailbox address. The user then inputs a password to receive messages, change their outgoing message, and the like.

However, this shortcut is not available if the user is calling from outside the system, such as from a home or mobile telephone. In such cases, users dial a common access phone number to access the voice mail system. They then enter a mailbox number (typically their office phone number or extension) and a password to receive messages, change their outgoing message, etc.

As can be appreciated, accessing from outside the system is relatively more cumbersome and time-consuming. The user must employ, for example, relatively more keystrokes and thus the potential for mis-dialing is relatively higher. Moreover, such potential for mis-keying may be increased because the sequence of inputs required for accessing from outside the system is different than for accessing from within the system.

As such, there is a need for an improved method for accessing a voice mail system from external the system. There is a further need for a voice mail system having a common log in process for internal and external access.

### SUMMARY OF THE INVENTION

These and other drawbacks in the prior art are overcome in large part by a system and method according to the present invention.

A voice mail system according to an embodiment of the present invention includes a database associating a plurality of calling party telephone numbers with a voice mail box. The system further includes a calling party telephone number identification unit for determining the number of a calling party. The system is accessible from external to the system by dialing an access telephone number. When a user from external to the system calls in, the calling party telephone number identification unit reads the number of the calling party. The database is accessed to determine if the calling party telephone number is associated with a system mailbox. If so, the system lets the user access the mailbox by entry of a password. Otherwise, the system requires the user to enter a specific mailbox number.

A telecommunications system according to an embodiment of the present invention includes a telecommunications switch, such as a private branch exchange (PBX) or telephony-over LAN (ToL) gateway-gatekeeper. The telecommunications switch includes a voice mail system including a plurality of mailboxes and a database associating a plurality of calling party telephone numbers with a voice mail box. The telecommunications switch also includes a calling party identification unit. The voice mail system is accessible from internal or external to the telecommunications system. The voice mail system is accessed internally via an access code; the voice mail system then accesses the database for the caller's extension. The user can then enter his password. Similarly, the system is accessed from outside the telecommunications system by dialing an access telephone number. The calling party identification unit reads the calling party number. The voice mail system then accesses the database for the calling party telephone number and determines if it is associated with a system mailbox. If the calling party telephone number is associated with a system mailbox, the calling party is prompted to enter a password. Otherwise, the calling party must first enter a mailbox number.

A method for providing access to a voicemail system according to an embodiment of the present invention includes reading calling party identification information; accessing a database to determine if the calling party number is associated with a mailbox in the system; prompting a caller for a password if the calling party number is associated with a mailbox; or prompting the caller for a mailbox number if the calling party number is not associated with a mailbox.

### BRIEF DESCRIPTION OF THE DRAWINGS

A better understanding of the invention is obtained when the following detailed description is considered in conjunction with the following drawings in which:

FIG. 1 is a block diagram of a telecommunications system according to an embodiment of the present invention;

FIG. 2 is a block diagram of a telecommunications switch according to an embodiment of the present invention;

FIG. 3 is a flowchart illustrating operation of an embodiment of the present invention;

FIG. 4 is a flowchart illustrating operation of an embodiment of the present invention;

FIG. 5 is a flowchart illustrating operation of an embodiment of the present invention;

FIG. 6 is a flowchart illustrating operation of an embodiment of the present invention; and

FIG. 7 is a block diagram of a telecommunications system according to an embodiment of the present invention.

### DETAILED DESCRIPTION OF THE INVENTION

Turning now to the drawings and, with particular attention to FIG. 1, a diagram of a telecommunications system 100 according to an embodiment of the present invention is shown. The system 100 includes a private telephone network 102 which may couple to one or more public telephone networks 101. As shown, the private telephone network 102 is embodied as a private branch exchange (PBX) based network, and includes a PBX 104 and a plurality of telephony devices 108a-108n. The PBX 104 may be a Hicom series PBX, available from Siemens Corp. The telephony devices 108a-108n may be telephones, fax machines, personal computers with telephony cards, and the like.

The public telephone network 101 may be the public switched telephone network (PSTN) including one or more central offices 112 coupling to the PBX 104. The public telephone network may also include one or more wireless switching centers 116, which may directly couple to the PBX 104 or via the central office 112. One or more telephony devices 110, such as telephones, fax machines, cordless telephones, personal computers with telephony cards, and the like, couple to the central office 116 and are able to communicate with the telephony devices 108a-108n of the private telephone network 102. Similarly, one or more wireless telephony devices 114 communicate via the wireless switching office 116. The wireless telephony devices may be embodied as wireless or cellular telephones, fax machines, personal digital assistants, or laptop personal computers with wireless telephony cards, and the like.

As will be explained in greater detail below, the PBX 104 includes a voice mail system (VMS) 106 and a calling party identification system 204. The voice mail system 106 is adapted to use information from the calling party identification unit 204 to determine an identity of a calling party and thereby permit a login shortcut. That is, the voice mail system 106 compares the number provided by the calling party identification unit 204. If the number is present in a database, assigned to a mailbox, the voice mail system 106 allows a login shortcut.

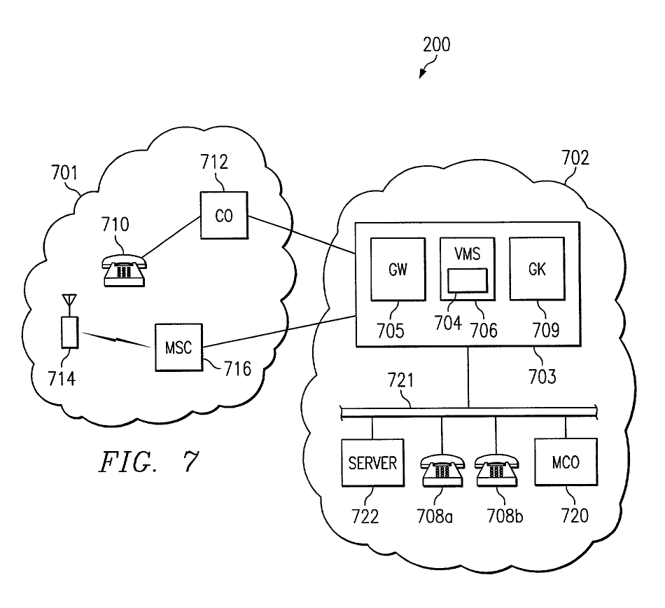

While operation of embodiments of the present invention will focus primarily on the embodiment of FIG. 1, the teachings of the present invention are not limited to the specific implementation shown therein. For example, FIG. 7 is a block diagram of a telecommunications system according to another embodiment of the present invention. In particular, the embodiment of FIG. 7 includes a voice packet network. Shown are a private telephone network 702 and one or more public telephone networks 701. The public telephone networks 701 may include one or more telephony devices 710 and central offices 712, as well as one or more mobile telephones 714 and wireless switches 716.

The private telephone network 702 may be implemented as a telephony over LAN (ToL) network or private voice over IP (VoIP) network. For example, the private telephone network 702 may implement a packet telephony protocol such as the H.323 Recommendation protocol or the Session Initiation Protocol (SIP). In the embodiment illustrated, the network implements the H.323 Recommendation. An exemplary H.323 compatible system is the HiPath system, available from Siemens Corp.

As shown, the private telephone network 702 includes a packet network 721 and a server 722. Coupled to the packet network 720 may be a plurality of telephony devices 708a, 708b, a multi-point control unit 720, and a switch unit 703. The switch unit 703 implements an H.323 gateway 705 for interfacing to the external network or networks, and H.323 gatekeeper functionality 709 for switching, control and signaling functions (It is noted that in other embodiments, the gateway and gatekeeper functionality may be provided in separate units coupled to the packet network.). In addition, the switch 703 includes a voicemail system 706 and a calling party identification unit 704 according to embodiments of the present invention. As in the embodiment of FIG. 1, the voicemail system 706 is adapted to use information from the calling party identification unit 704 to determine an identity of a calling party and thereby permit a login shortcut. The voice mail system 706 compares the number provided by the calling party identification unit 704. If the number is present in a database, assigned to a mailbox, the voice mail system 706 allows a login shortcut.

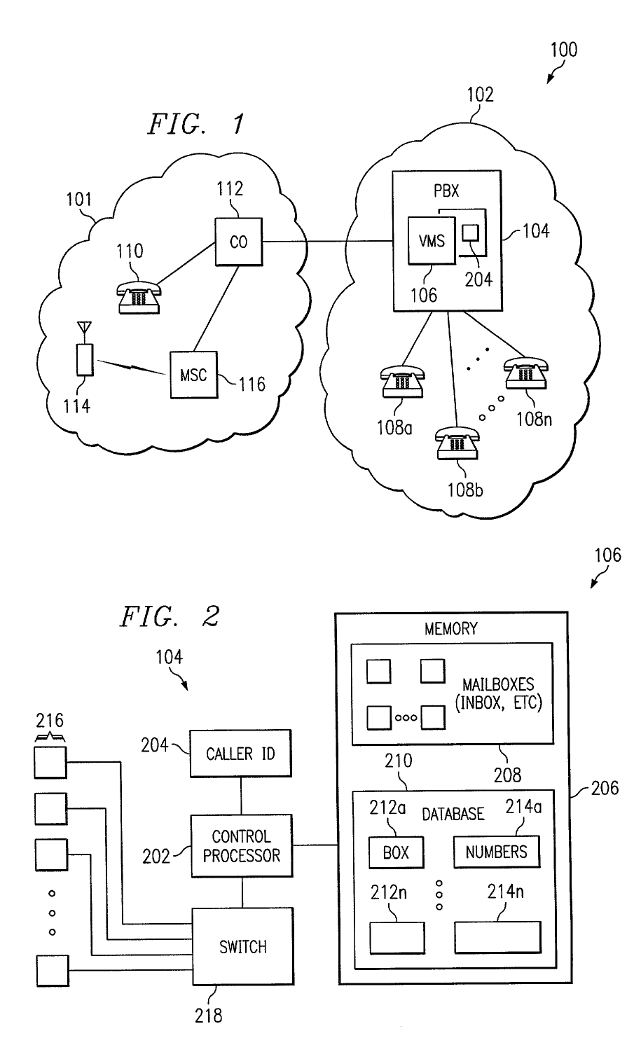

As noted above, operation of the present invention will focus primarily on the embodiment of FIG. 1; operation of other embodiments may be generally similar. More particularly, FIG. 2 is a block diagram of the PBX 104 of FIG. 1. As shown, the PBX 104 includes a plurality of input/output ports 216, a switching unit 218, a control unit 202, a caller identification unit 204, and a memory 206. The input/output ports 216 interface to the private telephone network 102 and the public telephone network 101 and are used to input and output signals to and from the switching unit 218. The switching unit 218 is used to switch the calls to the appropriate input/output port 216.

As will be explained in greater detail below, the controller 202 is adapted to control PBX switching and voice mail system operations. The controller 202 may be implemented as various combinations of hardware and software, including one or more microprocessors or microcontrollers or digital signal processors. The controller 202 thus may run program code (not shown) stored in the memory 206.

In addition, the memory 206 stores a plurality of user mailboxes 208 which may be arranged by a mailbox number. Typically, the mailbox number is the user's extension or telephone number. In addition, the memory 206 is used to maintain a database 210 of mailbox numbers 212a-212n and associated calling party telephone numbers 214a-214n, as will be explained in greater detail below.

The calling party identification unit 204 may be implemented as standard Caller Id or Calling Number Delivery (CND) message receivers, or as ISDN or other digital signaling receivers capable of receiving messages identifying the number of a calling party.

In operation, a user can program in desired telephone numbers to be associated with his mailbox. Such numbers can include, for example, home telephone or mobile telephone numbers associated with the public telephone network 101. Then, when the user dials the voice mail access telephone number to access the voice mail system from one of the associated telephone numbers, the calling party identification system 204 reads the number and provides it to the controller 202 The controller 202 then uses the calling party number to access the database 210 and determine if there is an associated mailbox on the voice mail system. If so, then the controller 202 will prompt the user to enter his password. Otherwise, the user is prompted to enter a mailbox number.

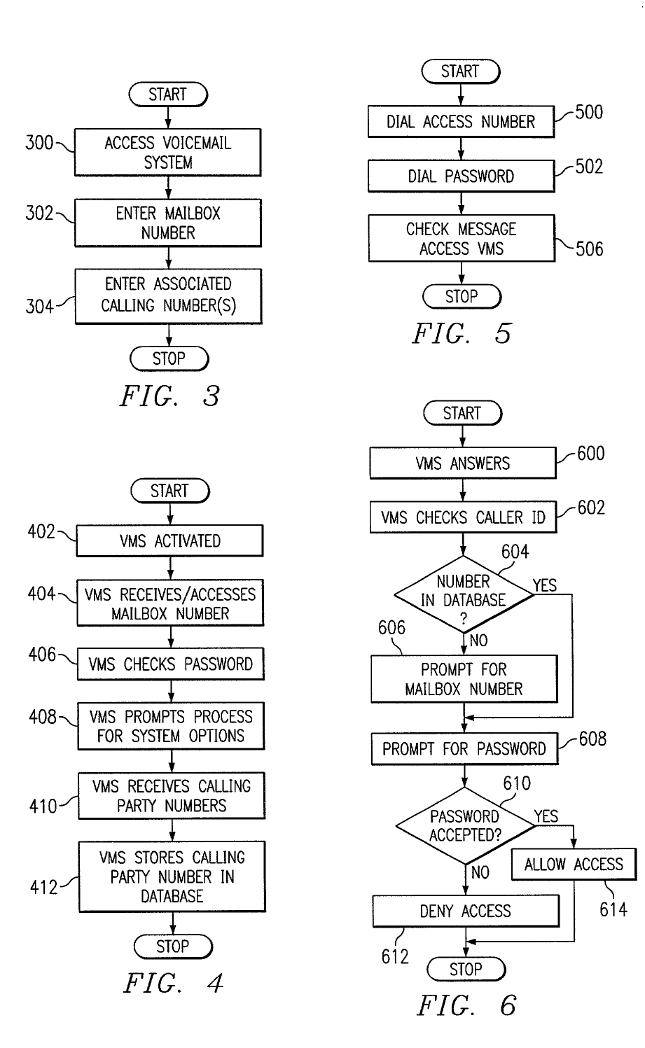

Operation of an embodiment of the present invention is illustrated with reference to the flowchart of FIG. 3. In particular, FIG. 3 illustrates a process by which a user may program the calling numbers which are to be associated with his mailbox. In step 300, the user accesses the voice mail system. The system, which may include an interactive voice response system, may then prompt the user for system managing, including associating calling numbers with the mailbox. In step 302, the user enters his mailbox number. It is noted that in other embodiments, the system may already know the user's mailbox number by virtue of the user logging in from his base telephone within the private network 102. Once the user has entered his mailbox number, or the system has been otherwise made aware of the user's mailbox number, he can select the option to associate calling numbers with his mailbox. The user does so, for example, by keying in or speaking the desired number or numbers. The user can then confirm and exit the system in a known manner.

Turning now to FIG. 4, a flowchart illustrating operation of the voicemail system 106 during calling number-mailbox registration is shown. In step 402, the voicemail system 106 activates, for example, in response to a user calling in from a system telephone within the private telephone network 102. In step 404, the voicemail system 106 accesses or receives the user's mailbox number. This may be accomplished, for example, by the user keying in the mailbox number, or through the voicemail system 106 determining which extension is being used to access the private telephone network 102. For example, the voicemail system controller 202 may determine which of the input-output ports 216 is being used to access the PBX 104 and thus obtain the extension. In step 406, the voicemail system 106 receives and checks the input user password. For example, the voicemail system 106 may prompt the user to enter the password with keystrokes on the keypad; the voicemail system may receive the keystrokes as DTMF (dual tone multifrequency) or other signaling. Alternatively, the user may speak the password, which is recognized by voice recognition techniques. The voicemail system then checks a database of passwords (not shown) to determine if the password corresponding to the mailbox has been entered. In step 408, the voicemail system 106 may prompt the user to select one or a plurality of system options. If the user elects the calling number-mailbox association option, then in step 410, the voicemail system 106 may receive the calling party number as input by the user. Again, the user may input the number using the keypad, or by speaking the number. Finally, in step 412, the voicemail system 412 stores the input calling party number in the database 210 in association with the mailbox number or identification. The system may then accept further calling party numbers in association with the mailbox number, or may allow the user to exit the system.

It is noted that, in alternate embodiments, the user may enter the calling party number associations from a telephone external the private network. In such embodiments, the calling party identification unit may be used to automatically associate a calling party number with the mailbox. For example, if calling from a telephone in one of the public networks, once the voicemail system has been accessed (and password provided and verified), the system may ask whether the user wishes that the number identified by the calling party identification unit be associated with his mailbox. If so, the user can select one or more function keys and the system will associate the number with the mailbox as described above.

Use of an embodiment of the present invention to access the voicemail system 106 is illustrated in the flowchart of FIG. 5. In step 500, the user dials an access telephone number from a telephony device outside the private telephone network 102, i.e., from the public telephone network 101. Once the voicemail system picks up, the user has access to the voicemail system 106. The voicemail system 106 then reads the calling party identification information accompanying the call set up and prompts the user for a password, which the user inputs in step 502. If the password is approved, then the system prompts the user to check the messages or otherwise access system functionality, in step 506.

It is noted that, in certain embodiments, entry of any system-recognized password from any recognized outside calling party number may allow access to the mailbox associated with the password.

Further, while described above in conjunction with an automatic identification of the caller and password prompt, in other embodiments, the system may provide a confirmation message and prompt prior to and in addition to the password prompt once the calling number has been identified. If the caller rejects the confirmation, he may be prompted to enter the mailbox number explicitly.

Turning now to FIG. 6, a flowchart illustrating operation of the voicemail system 106 during user access from external to the private telephone network 102 is shown. In step 600, the voicemail system 106 responds to an attempt to access it, e.g., by a call to a voicemail access number. In step 602, the voice mail system 106 checks the calling party identification unit 204 to determine the calling party number. As noted above, the calling party identification may take the form of Caller ID or other signaling. In step 604, the voicemail system 106 and, in particular, the controller 202 determines if the received calling party number is present in the database 210. If the calling party number is present in the database, the system accesses the mailbox number and password file, and prompts the user to input the password, in step 608. If the calling party number is not present in the database 210, then in step 606, the voicemail system 106 prompts the caller to input a mailbox number. The system then prompts the user for the password, in step 608. Once the password is received, for example, by reading DTMF tones or voice recognition techniques, the controller 202 checks whether to accept or reject the password, in step 610. If the password does not match the stored password, then in step 612, the controller 202 denies access to the voicemail system. Otherwise, in step 614, the controller 202 allows the user access to voicemail system functionality.

The invention described in the above detailed description is not intended to be limited to the specific form set forth herein, but is intended to cover such alternatives, modifications and equivalents as can reasonably be included within the spirit and scope of the appended claims.

What is claimed is:

1. A voicemail system, comprising:
a controller;
a plurality of user mailboxes;
a database associating one or more external telephone numbers with at least one of said plurality of user mailboxes;
a calling party identification unit adapted to determine a telephone number of a calling party;
wherein said controller is adapted to access the database and allow a caller access to a mailbox if the calling party telephone number of the calling party is associated with a mailbox.

2. A voicemail system in accordance with claim 1, wherein said controller is adapted to prompt a calling party for a password if the calling party telephone number is associated with a mailbox.

3. A voicemail system in accordance with claim 2, wherein said controller is adapted to prompt a calling party for a mailbox identification if the calling party number is not associated with a mailbox.

4. A voicemail system in accordance with claim 1, wherein said calling party identification unit comprises a caller ID unit.

5. A method for providing access to a voicemail system, comprising:
reading calling party identification information;
accessing a database to determine if the calling party number is associated with a mailbox in the system;
prompting a caller for a password if the calling party number is associated with a mailbox; or
prompting the caller for a mailbox number if the calling party number is not associated with a mailbox.

6. A method, comprising:
providing a controller;
providing a plurality of user mailboxes;
providing a database associating one or more external telephone numbers with at least one of said plurality of user mailboxes;
providing a calling party identification unit adapted to determine a telephone number of a calling party;
wherein said controller is adapted to access the database and allow a caller access to a mailbox if the calling party telephone number of the calling party is associated with a mailbox.

7. A method in accordance with claim 6, wherein said controller is adapted to prompt a calling party for a password if the calling party telephone number is associated with a mailbox.

8. A method in accordance with claim 7, wherein said controller is adapted to prompt a calling party for a mailbox identification if the calling party number is not associated with a mailbox.

9. A method in accordance with claim 8, wherein said calling party identification unit comprises a caller ID unit.

10. A telecommunications switch, comprising:
a switching unit coupled to a plurality of input-output ports adapted to interface to incoming and outgoing telephone calls; and
a voicemail system, the voicemail system comprising:
a controller;
a plurality of user mailboxes;
a database associating one or more external telephone numbers with at least one of said plurality of user mailboxes;
a calling party identification unit adapted to determine a telephone number of a calling party;
wherein said controller is adapted to access the database and allow a caller access to a mailbox if the calling party telephone number of the calling party is associated with a mailbox.

11. A telecommunications switch in accordance with claim 10, wherein said controller is adapted to prompt a calling party for a password if the calling party telephone number is associated with a mailbox.

12. A telecommunications switch in accordance with claim 11, wherein said controller is adapted to prompt a calling party for a mailbox identification if the calling party number is not associated with a mailbox.

13. A telecommunications switch in accordance with claim 10, said switching unit comprising a private branch exchange (PBX) switching unit.

14. A telecommunications switch in accordance with claim 10, switching unit comprising a telephony-over-LAN switching unit.

15. A telecommunications system, comprising a private telephone network adapted to interface to and communicate with a public telephone network, the private telephone network including a voicemail system, the voicemail system comprising:
a database associating telephone numbers of telephones on said public telephone network with mailboxes in said voicemail system; and
a controller adapted to access said database responsive to an incoming call to said voicemail system from the public telephone network and determine if a number of the calling party is associated with a mailbox in said voicemail system.

16. A telecommunications system in accordance with claim 15, wherein said controller is configured to prompt a caller to enter a password if the caller's telephone number is associated with a mailbox.

17. A telecommunications system in accordance with claim 18, wherein said controller is configured to prompt a caller to enter a mailbox number if the caller's telephone number is not associated with a mailbox.

18. A telecommunications system in accordance with claim 15, wherein said private telephone network comprises a private branch exchange (PBX) based network.

19. A telecommunications system in accordance with claim 15, wherein said private telephone network comprises a telephony-over-LAN (ToL) based network.
